(19) United States
(12) Patent Application Publication
(10) Pub. No.: US 2025/0354341 A1
(43) Pub. Date: Nov. 20, 2025

(54) POLYMERIC MODIFIED CEMENT COMPOSITIONS AND METHODS OF MANUFACTURE THEREOF

(71) Applicant: W. Robert Wilson, Boonton, NJ (US)

(72) Inventor: W. Robert Wilson, Boonton, NJ (US)

(21) Appl. No.: 18/664,832

(22) Filed: May 15, 2024

(51) Int. Cl. E01F 9/518; C04B 24/26; C04B 28/06; C04B 40/06; C04B 111/00; E01C 23/20; E01F 9/524; E01F 9/576

(52) U.S. Cl. CPC E01F 9/518; C04B 24/2641; C04B 28/06; C04B 40/065; E01C 23/20; E01F 9/524; E01F 9/576; C04B 2111/00172; C04B 2111/0075

(57) ABSTRACT

A method for providing a polymer modified cement overlay on a surface that is configured for vehicular and/or human transportation includes preparing a wet cement mixture by mixing a dry polymer cement mixture including a cement, an aggregate, and a polymer in particulate form with a first water-containing liquid; preparing a wet calcium aluminate cement mixture by mixing a dry calcium aluminate cement mixture with a second water-containing liquid; mixing the wet calcium aluminate cement mixture with the wet cement mixture to form a quick setting polymer modified cement composition; and applying the quick setting polymer modified cement composition to the surface to form the polymer modified cement overlay.

### FIELD OF THE INVENTION

The present invention relates to a polymer modified cement composition and methods of manufacturing and use thereof.

### BACKGROUND OF THE INVENTION

Pavement surfaces are constructed to carry traffic such as vehicles (e.g., automobiles, bikes, construction equipment) and humans and therefore may need to be coated or marked for various reasons, including for preservation, performance enhancement (e.g., friction, visibility), safety (e.g., to show divided lanes, segregated oncoming traffic, identify routes, provide directions), and for aesthetic purposes. However, slow curing times associated with existing cement compositions may prevent the pavement surface from being traffic-ready in a desirable time. As such, there remains a need for a quick setting composition that is traffic-ready shortly after application.

### SUMMARY OF THE INVENTION

In exemplary embodiments, a surface configured for vehicular and/or human transportation includes a polymer modified cement composition. The polymer modified cement composition includes a first cement mixture including a cement, an aggregate, a polymer in particulate form, and a first water-containing liquid. The polymer modified cement composition further includes a second cement mixture including a cementitious agent, and a second water-containing liquid.

In some embodiments, the first water-containing liquid and the second water-containing liquid are the same or different.

In some embodiments, the polymer in particulate form includes an acrylate-based compound.

In some embodiments, the cement includes partially refined Portland cement.

In some embodiments, the cementitious agent is an amorphous cementitious agent.

In some embodiments, the amorphous cementitious agent includes at least one amorphous compound selected from the group consisting of aluminum oxide, calcium oxide, and silicon dioxide.

In some embodiments, the amorphous cementitious agent includes aluminum oxide, calcium oxide, silicon dioxide, and sulfur trioxide.

In some embodiments, the amorphous cementitious agent includes a calcium aluminate compound.

In some embodiments, the cementitious agent is a calcium aluminate compound.

In some embodiments, the cementitious agent is an amorphous calcium aluminate compound.

In some embodiments, the first cement mixture further includes at least one additional component selected from the group consisting of microfibers, plasticizers, fillers, accelerators, and retarders.

In some embodiments, the second cement mixture further includes at least one of the aggregate and the polymer in a particulate form.

In some embodiments, the amorphous cementitious agent is present in an amount of less than 15 wt. % of the total weight of the composition.

In some embodiments, the cementitious agent is present in an amount of less than 10 wt. % of the total weight of the composition.

In some embodiments, the aggregate includes a material selected from the group consisting of marble dust, sand, crushed rocks, and mixtures thereof.

In exemplary embodiments, a method for providing a polymer modified cement overlay on a surface that is configured for vehicular and/or human transportation includes preparing a wet cement mixture by mixing a dry polymer cement mixture including a cement, an aggregate, and a polymer in particulate form with a first water-containing liquid; preparing a wet calcium aluminate cement mixture by mixing a dry calcium aluminate cement mixture with a second water-containing liquid; mixing the wet calcium aluminate cement mixture with the wet cement mixture to form a quick setting polymer modified cement composition; and applying the quick setting polymer modified cement composition to the surface to form the polymer modified cement overlay.

In some embodiments, the dry calcium aluminate cement mixture is amorphous.

In some embodiments, the first water-containing liquid and the second water-containing liquid are the same or different

In some embodiments, the polymer modified cement overlay is workable within fifteen minutes of application.

In some embodiments, the polymer modified cement overlay is workable within ten minutes of application.

In some embodiments, the polymer modified cement overlay is workable within one minute of application.

In some embodiments, applying the polymer modified cement composition to the substrate includes spraying the polymer modified cement composition on the one or more surfaces of the substrate.

In some embodiments, applying the polymer modified cement composition to the substrate includes providing the polymer modified cement composition to a vehicle capable of applying the polymer modified cement composition to the substrate.

In some embodiments, the polymer modified cement overlay has a thickness of less than or equal to 125 mils.

In some embodiments, the polymer modified cement overlay has a thickness of less than or equal to 62.5 mils.

In some embodiments, the surface includes one or more of asphalt, concrete, and metal.

In some embodiments, the surface is asphalt.

In some embodiments, the surface is concrete.

In some embodiments, the method further includes a step of embedding reflective beads into the polymer modified cement overlay.

In some embodiments, the aggregate includes a material selected from the group consisting of marble dust, sand, crushed rocks, and mixtures thereof.

In some embodiments, applying the polymer modified cement composition includes applying the polymer modified cement composition as markings on the surface.

In some embodiments, the step of mixing the wet calcium aluminate cement mixture with the wet cement mixture includes mixing via a static mixer.

In some embodiments, the step of preparing the wet calcium aluminate cement mixture includes mixing the dry calcium aluminate cement mixture, a portion of the aggregate, and a portion of the polymer with the second water-containing liquid.

In some embodiments, the polymer modified cement overlay is workable at surface temperatures below 40 degrees F.

In exemplary embodiments, a method for providing a polymer modified cement overlay on a surface that is configured for vehicular and/or human transportation includes housing a first cement mixture including a cement, an aggregate, a polymer in particulate form, and a first water-containing liquid in a striping vehicle; housing a second cement mixture including a cementitious agent and a second water-containing liquid in the striping vehicle, wherein the first water-containing liquid and the second water-containing liquid may be the same or different; mixing the second cement mixture with the first cement mixture to form a polymer modified cement composition; applying the polymer modified cement composition from the striping vehicle to the surface to form the polymer modified cement overlay.

In some embodiments, the cementitious agent is an amorphous cementitious agent.

In some embodiments, the polymer modified cement overlay is workable within fifteen minutes of application.

In some embodiments, the polymer modified cement overlay is workable within ten minutes of application.

In some embodiments, the polymer modified cement overlay is workable within one minute of application.

In some embodiments, applying the polymer modified cement composition from the striping vehicle to the substrate includes spraying the polymer modified cement composition on the surface via one or more nozzles of the striping vehicle.

In some embodiments, the polymer modified cement overlay has a thickness of less than or equal to 125 mils.

In some embodiments, the polymer modified cement overlay has a thickness of less than or equal to 62.5 mils.

In some embodiments, the surface includes one or more of asphalt, concrete, and metal.

In some embodiments, the surface is asphalt.

In some embodiments, the surface is concrete.

In some embodiments, the method further includes a step of embedding reflective beads into the polymer modified cement overlay.

In some embodiments, the aggregate includes a material selected from the group consisting of marble dust, sand, crushed rocks, and mixtures thereof.

In some embodiments, the step of mixing includes mixing via a static mixer.

In exemplary embodiments, a method of forming a polymer modified cement composition includes preparing a first cement mixture including a cement, an aggregate, a polymer in particulate form, and a first water-containing liquid; adding a second cement mixture including a cementitious agent and a second water-containing liquid to the cement mixture to form the polymer modified cement composition, wherein the first water-containing liquid and the second water-containing liquid may be the same or different.

In some embodiments, the cementitious agent is an amorphous cementitious agent.

In some embodiments, the amorphous cementitious agent includes at least one amorphous compound selected from the group consisting of aluminum oxide, calcium oxide, and silicon dioxide.

In some embodiments, the amorphous cementitious agent includes aluminum oxide, calcium oxide, silicon dioxide, and sulfur trioxide.

In some embodiments, the polymer in particulate form includes an acrylate-based compound.

In some embodiments, the first cement mixture further includes at least one additional component selected from the group consisting of microfibers, plasticizers, fillers, accelerators, and retarders.

In some embodiments, the aggregate includes a material selected from the group consisting of marble dust, sand, crushed rocks, and mixtures thereof.

In exemplary embodiments, a kit for forming a polymer modified cement composition includes a cement mixture including a cement, an aggregate, and a polymer in particulate form; a first water-containing liquid; a cementitious agent; and a second water-containing liquid, wherein the first water-containing liquid and the second water-containing liquid may be the same or different.

In some embodiments, the cementitious agent is an amorphous cementitious agent.

In some embodiments, the amorphous cementitious agent includes at least one amorphous compound selected from the group consisting of aluminum oxide, calcium oxide, and silicon dioxide.

In some embodiments, the amorphous cementitious agent includes aluminum oxide, calcium oxide, silicon dioxide, and sulfur trioxide.

In some embodiments, the first water-containing liquid is configured to contact the cement mixture to form a liquified cement mixture, and wherein the second water-containing liquid is configured to contact the amorphous cementitious agent to form a liquified amorphous cementitious agent, wherein the liquified amorphous cementitious agent is configured to contact the liquified cement mixture.

In some embodiments, the polymer in particulate form includes an acrylate-based compound.

In some embodiments, the cement mixture further includes at least one additional component selected from the group consisting of microfibers, plasticizers, fillers, accelerators, and retarders.

In some embodiments, the aggregate includes a material selected from the group consisting of marble dust, sand, crushed rocks, and mixtures thereof.

In exemplary embodiments, a method for preparing a rapidly setting polymer modified cement includes providing a first vessel including a cement mixture including a cement, an aggregate, a polymer in particulate form, and a first water-containing liquid; providing a second vessel including a cementitious agent slurry including a cementitious agent and a second-water containing liquid; and contacting the cement mixture with the cementitious agent slurry to form a polymer modified cement composition.

In some embodiments, contacting the cement mixture with the cementitious agent includes providing the cement mixture and the cementitious agent slurry to a static mixer.

In some embodiments, the first water-containing liquid and the second water-containing liquid may be the same or different

In some embodiments, the polymer in particulate form includes an acrylate-based compound.

In some embodiments, the cementitious agent is an amorphous cementitious agent.

In some embodiments, the amorphous cementitious agent includes at least one amorphous compound selected from the group consisting of aluminum oxide, calcium oxide, and silicon dioxide.

In some embodiments, the amorphous cementitious agent includes aluminum oxide, calcium oxide, silicon dioxide, and sulfur trioxide.

In some embodiments, the cement mixture further includes at least one additional component selected from the group consisting of microfibers, plasticizers, fillers, accelerators, and retarders.

In some embodiments, the aggregate includes a material selected from the group consisting of marble dust, sand, crushed rocks, and mixtures thereof.

In some embodiments, the polymer modified cement overlay is workable at surface temperatures below 40 degrees F.

### BRIEF DESCRIPTION OF THE DRAWINGS

The following figures are meant to reflect specific embodiments of the invention and are not intended to otherwise limit the scope of the invention as described herein.

FIG. 1 shows an exemplary process for preparing a polymer modified cement composition according to an embodiment of the present invention;

FIG. 2 shows an exemplary process flow for applying a polymer modified cement composition to a substrate according to an embodiment of the present invention;

FIG. 3 shows a block flow diagram of an exemplary striping truck configured to house and apply a polymer modified cement composition to a substrate according to an embodiment of the present invention;

FIG. 4 shows an exemplary substrate (e.g., road having one or more lanes in each direction) with markings according to an embodiment of the present invention; and

FIG. 5 shows an exemplary cross section of a polymer modified cement composition marked substrate according to an embodiment of the present invention.

### DETAILED DESCRIPTION OF THE INVENTION

The following description is of exemplary embodiments and methods of use that are presently contemplated for carrying out the present invention. This description is not to be taken in a limiting sense but is made merely for the purpose of describing the general principles and features of various aspects of the present invention. The scope of the present invention is not limited by this description.

Unless defined otherwise, all terms used herein have the same meanings as commonly understood by one of ordinary skill in the art to which this invention belongs. Specific compositions and methods are described, although any materials and methods similar or equivalent to those described herein can be used in the practice or testing of the present invention.

### Polymer Modified Cement Composition

Present embodiments relate to a polymer modified cement composition. The polymer modified cement composition may be provided as an overlay and have excellent initial and long-term bonding to substrates. It is contemplated that the polymer modified cement composition may not soften at elevated temperatures or embrittle at lower temperatures and may be resistant to traffic and weathering. It is further contemplated that the polymer modified cement composition may also act as an adhesive layer (similar to epoxy, polyurethane, and bitumen) where objects may be partially or wholly received thereby and secured therein once cured.

According to one embodiment, the polymer modified cement composition includes a first cement mixture and a second cement mixture. The first cement mixture may include a dry mix including a cement (e.g., ordinary Portland cement), an aggregate, a polymer, and optionally one or more components including but not limited to microfibers, plasticizers, fillers, accelerators, retarders, pigments, and mixtures thereof. Polymeric aggregate cement mixtures are well-known in the art and are described in, for example, U.S. Pat. Nos. 8,784,557, 10,221,527, 10,654,751, U.S. Pat. Pub. No. 2022/0098123, and U.S. Pat. Pub. No. 2023/0312420, the entire contents of all of which are incorporated herein by reference. In preferred embodiments, the first cement mixture further includes a first water-containing liquid.

It is contemplated that based on the total amount of the dry mix of the first cement mixture, the proportion of the cement may be between 30-60 wt. %, between 35-55 wt. %, or between 40-50 wt. %, the proportion of the aggregate may be between 30-60 wt. %, between 35-55 wt. %, or between 40-50 wt. %, the proportion of the polymer may be between 2-12 wt. %, between 3-10 wt. %, or between 5-8 wt. %, and the proportion of the one or more optional components may be between 0.5-9 wt. %, between 1-7 wt. %, or between 2-5 wt. %. The first-water containing liquid may be present in an amount between 13-26 wt. %, between 14-24 wt. %, or between 16-20 wt. % of the dry mix of the first cement mixture.

The second cement mixture may include a dry mix including a cementitious agent and optionally an aggregate and/or a polymer. In certain embodiments, the cementitious agent is an amorphous cementitious agent. As used herein, the term “amorphous” means the substantial absence of crystallinity, e.g., solid structures having less than 5% or less than 1% crystallinity. In preferred embodiments, the second cement mixture further includes a second water-containing liquid. In some embodiments, based on the total amount of the dry mix of the second cement mixture, the proportion of the cementitious agent may be 100 wt. %. In further embodiments, based on the total amount of the dry mix of the second cement mixture, the proportion of the cementitious agent may be between 80-98 wt. %, between 83-95 wt %, or between 86-92 wt. %, and the proportion of the polymer may be between 2-20 wt. %, between 5-17 wt. %, or between 8-14 wt. %. In even further embodiments, based on the total amount of the dry mix of the second cement mixture, the proportion of the cementitious agent may be between 30-60 wt. %, between 35-55 wt %, or between 40-50 wt. %, the proportion of the polymer may be between 2-12 wt. %, between 3-10 wt. %, or between 5-8 wt. %, and the proportion of the aggregate may be between 30-60 wt. %, between 35-55 wt %, or between 40-50 wt. %. The second-water containing liquid may be present in an amount between 35-70 wt. %, between 40-60 wt. %, or between 45-55 wt. % of the dry mix of the second cement mixture.

In some embodiments, the first water-containing liquid of the first cement mixture and the second water-containing liquid of the second cement mixture are the same. In alternative embodiments, the first water-containing liquid of the first cement mixture and the second water-containing liquid of the second cement mixture are different.

The aggregate of the first cement mixture may be a coarse material or a fine material or an ultrafine material. The aggregate may be a material selected from the group consisting of marble dust, sand, crushed rocks, gravel, and mixtures thereof, or any other suitable material. One of ordinary skill in the art will appreciate that marble dust includes compounds in particulate form having greater than or equal to 95 mass % calcium carbonate. Other suitable aggregates are described in for example, U.S. Pat. Nos. 8,784,557, 10,221,527, 10,654,751, U.S. Pat. Pub. No. 2022/0098123, and U.S. Pat. Pub. No. 2023/0312420.

It is contemplated that the aggregate is configured to provide layer thickness, improve mixing, and/or limit segregation of the composition. The aggregate may further provide a rough surface that can increase the skid resistance of the composition. It is further contemplated that in some preferred embodiments, the aggregate has gradations that meet the ASTM C144 specification. Using aggregate gradations that meet the ASTM C144 specification may produce a polymer modified cement composition that can be placed relatively thin. The ASTM C144 specification provides an optimum gradation that is intended to consume a moderate quantity of cement, produces a wet mix that is workable without having to use too much water or additives, does not shrink excessively, and cures at an appropriate rate to allow a bond to develop with the underlying substrate. However, this ASTM standard does not apply to ultrathin polymer modified cement mixtures that use fine or ultrafine aggregate material, such as marble dust.

In certain embodiments, the polymer of the first cement mixture is a dry polymer. In a preferred embodiment, the polymer is in particulate (e.g., powder) form. The polymer may include one or more polymer compounds of monomer units, one or more copolymer compounds of monomer units, one or more terpolymer compounds of monomer units, and/or mixtures thereof. It is contemplated that the monomer units may include but are not limited to acrylic monomers, stearyl acrylate monomers, styrene acrylic monomers, vinal acetate monomers, vinyl acetate ethylene monomers, vinyl chloride ethylene monomers, polyvinyl acetate monomers, styrene-butadiene resins, and/or mixtures thereof.

According to some embodiments, the first cement mixture may optionally include microfibers. It is contemplated that the microfibers may be configured to limit segregation, limit shrinkage, limit exothermal generation, and improve workability. The microfibers may be polypropylene microfibers.

According to some embodiments, the first cement mixture may optionally include one or more plasticizers. It is contemplated that the plasticizer may be configured to increase workability. The plasticizers may be mineral admixtures (fly ash, metakaolin, and/or silica fume) or chemical admixtures (air-entrancing agents and/or water-reducers, such as superplasticizers).

According to some embodiments, the first cement mixture may optionally include one or more fillers. It is contemplated that the filler may be configured to enhance workability, limit segregation and shrinkage and increase long term compressive strength. The filler may be a pozzolanic filler, such as fly ash (e.g., class C or class F fly ash). A pozzolanic filler advantageously does not exhibit alkali silica reaction tendencies and improves the workability of the cement mixture.

According to some embodiments, the first cement mixture may optionally include one or more accelerators. It is contemplated that the accelerator may be configured to accelerate curing as may be needed for nighttime applications and time sensitive applications. The accelerators may be compounds such as calcium compounds, aluminum compounds, silicate, triethanolamine, carbonates, soluble chlorides, or fluorosilicates. According to some embodiments, the first cement mixture may also optionally include one or more retarders. For example, the cement mixture may include an accelerator together with a retarder to delay the change in workability that comes from adding the accelerator. The retarders may include compounds such as calcium sulphate, acids (tartaric and citric), phosphonates, cellulose products (sucrose, glucose), sodium gluconate, Rochelle salt and cream of tartar, lignosulphonates, starches, hydroxycarboxylic acids, borates, and mixtures thereof.

According to some embodiments, the first cement mixture may optionally include one or more pigments for coloring. The pigments may include natural and synthetic pigments, such as but not limited to iron oxide, cobalt, titanium dioxide, and chromium oxide.

As described above, the second cement mixture may include a cementitious agent, preferably an amorphous cementitious agent. The cementitious agent may include calcium aluminate compounds, preferably amorphous calcium aluminate compounds. In some embodiments, the cementitious agent may include amorphous calcium aluminate compounds blended with calcium sulfate.

In some embodiments, the cementitious agent may include at least one amorphous compound selected from the group consisting of aluminum oxide, calcium oxide, and silicon dioxide. In preferred embodiments, the cementitious agent is an amorphous cementitious agent which includes aluminum oxide (e.g. between 10-40 wt %, preferably between 15-30 wt % based on the total weight of the cementitious agent), calcium oxide (e.g. between 20-60 wt %, preferably between 30-50 wt % based on the total weight of the cementitious agent), silicon dioxide (e.g. between 0.1-20 wt %, preferably between 1-10 wt % based on the total weight of the cementitious agent), and sulfur trioxide (e.g. between 10-50 wt %, preferably between 20-40 wt % based on the total weight of the cementitious agent). The cementitious agent may have a particle size diameter range with a D90 of less than 100 μm, preferably between 10-60 μm. The cementitious agent may further have particle size diameter range with a D50 of 1-25 μm, preferably between 2-15 μm.

In some embodiments, the cementitious agent may include an ettringite forming substance. Without intending to be bound to a particular theory, it is contemplated that formation of ettringite may play an important role in the setting of a cement mixture. An ettringite forming substance may therefore advantageously decrease the time needed for the mixture to set.

In some embodiments, an inherent color (e.g., color prior to addition of any pigments, dyes, or other coloring-agents) of the cementitious agent may be white or substantially white. It is therefore contemplated that the polymer modified cement composition may be white or substantially white after addition of the second cement mixture including the cementitious agent. Such embodiments may be advantageous for applications in which a white-colored composition is needed, as adding pigments may increase the time needed for the composition to set.

As described above, the second cement mixture may optionally include an aggregate and/or a polymer. The aggregate of the second cement mixture may be the same as or different than the aggregate of the first cement mixture, and the polymer of the second cement mixture may be the same as or different than the polymer of the first cement mixture.

It is contemplated that the second cement mixture may be present in an amount between 6-25 wt. %, between 8-20 wt. %, or between 10-15 wt. % based on the total amount of the first cement mixture. It is contemplated that the amount of second cement mixture, and particularly the amount of the cementitious agent, may vary depending on various factors, including but not limited to the type or source of Portland cement used in the first cement mixture, the temperature and humidity of the surrounding environment, the time of day, whether the substrate is wet or dry. One of ordinary skill in the art will understand that Portland cement may differ somewhat in composition from source to source, and will further understand that the relative amount of the second cement mixture or the cementitious agent may be determined through evaluation of different amounts of the agent (e.g., beginning with 6 wt. % of the second cement mixture and then adjusting upwards or downwards depending on results) from one batch of Portland cement to another.

In some embodiments, the polymer modified cement composition may be free or substantially free of lithium or lithium-containing compounds.

### Method of Manufacture

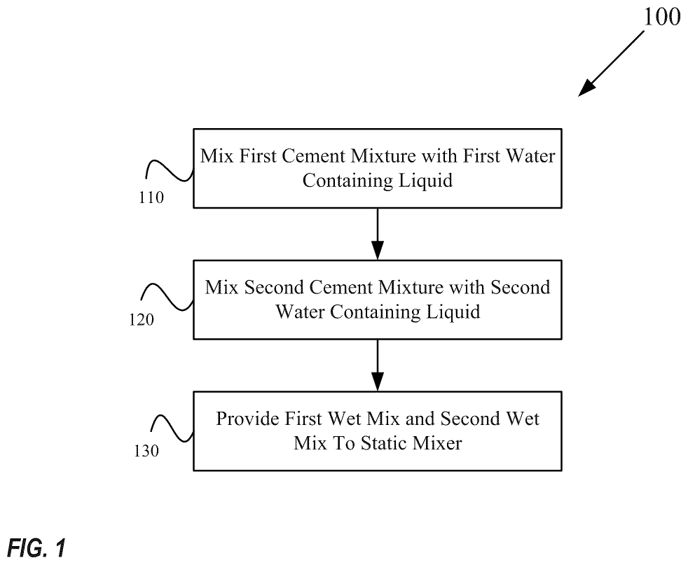

Present embodiments further relate to methods of forming a polymer modified cement composition. Methods may include preparing a first cement mixture and separately preparing a second cement mixture. FIG. 1 illustrates an exemplary process 100 for preparing a polymer modified cement composition. In particular, the first cement mixture is prepared by combining the cement (e.g., ordinary Portland cement), the aggregate, the polymer, and optionally one or more additional components, such as microfibers, plasticizers, fillers, accelerators, retarders, with the first water-containing liquid 110. A wet (e.g., aqueous) first cement mixture is thereby formed. The second cement mixture is prepared by combining the cementitious agent (and optionally an aggregate and/or a polymer) with the second water-containing liquid 120. A wet (e.g., aqueous) second cement mixture is thereby formed.

The polymer modified cement composition may then be formed by contacting or combining an appropriate amount of wet first cement mixture with an appropriate amount of wet second cement mixture 130. In some embodiments, the wet first cement mixture may be combined with the wet second cement mixture via a mixer, such as a static mixer. It is contemplated that it is easier and faster to contact or combine the first cement mixture and second cement mixture when in wet forms. It is further contemplated that the second cement mixture may not begin to set when in an aqueous form alone, or that the second cement mixture may set slowly when in an aqueous form alone, and it is not until the second cement mixture is contacted or combined with the alkaline first cement mixture that its quick setting property advances.

The first cement mixture and the second cement mixture may be delivered to a site of application with all of their dry components mixed together, for example all components other than the water-containing liquids. The first water-containing liquid may then be combined with the dry components of the first cement mixture at the site to form a first cement mixture in wet form, and the second water-containing liquid may be combined with the dry component of the second cement mixture at the site to form a second cement mixture in wet form. The wet first and second cement mixtures may then be combined prior to application.

In some embodiments, the wet first cement mixture may be stored in a first vessel, and the wet second cement mixture may be stored in a second vessel.

In some embodiments, a vehicle (e.g., striping vehicle) may house the first cement mixture and the second mixture in wet forms. The vehicle may include a first storage or housing to house the first cement mixture and a second storage or housing to house the second cement mixture, and the vehicle may be configured to contact or combine the first cement mixture and the second cement mixture in wet forms to form the polymer modified cement composition before application.

### Method of Application

Present embodiments further relate to methods of using a polymer modified cement composition, such as methods of applying a polymer modified cement composition to a substrate to form a polymer modified cement overlay. The substrate may be any suitable surface on which the polymer modified cement composition may be applied, such as asphalt, concrete, or metal. For example, the substrate may include sealcoats; single chip, double chip or cape seals; all asphalt slurry types; all asphalt micro surfaces; thin hot mix flexible asphalt pavement surfaces with high surface deflections (=0.8 mm deflection); thick hot mix flexible asphalt pavement surfaces with low surface deflections (≤0.8 mm deflection); all Portland cement concrete pavements; roller compacted concrete; and white topping. It is contemplated that the substrate may be wet or dry.

The polymer modified cement composition may be applied to one or more surfaces of the substrate using standard processes, such as via an extruder, ribbon, squeegee, screeder or sprayer (e.g., using a spray gun, or spray bar). It is contemplated that such techniques may enable an overlay with a uniform or substantially uniform thickness. Other suitable machinery and/or processes are described in for example, U.S. Pat. Nos. 8,784,557, 10,221,527, 10,654,751, U.S. Pat. Pub. No. 2022/0098123, and U.S. Pat. Pub. No. 2023/0312420.

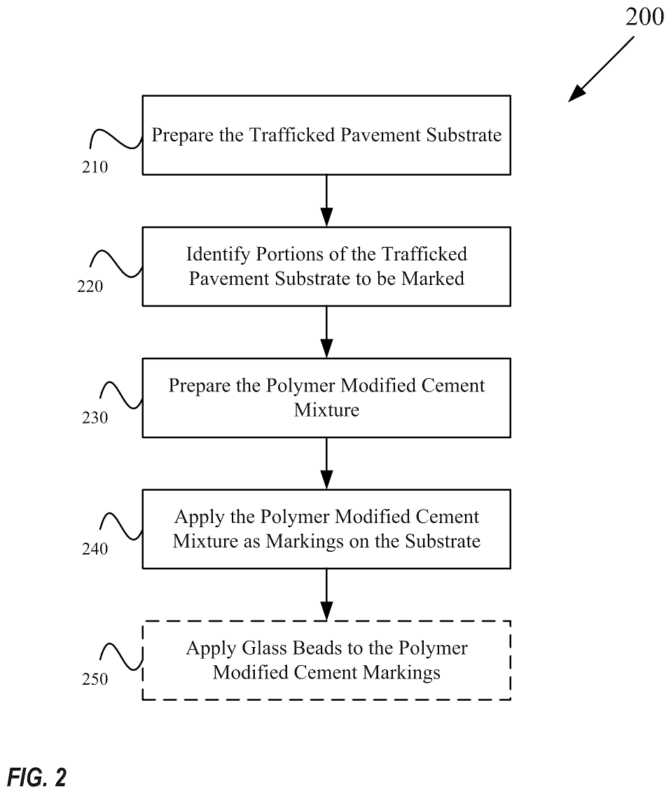

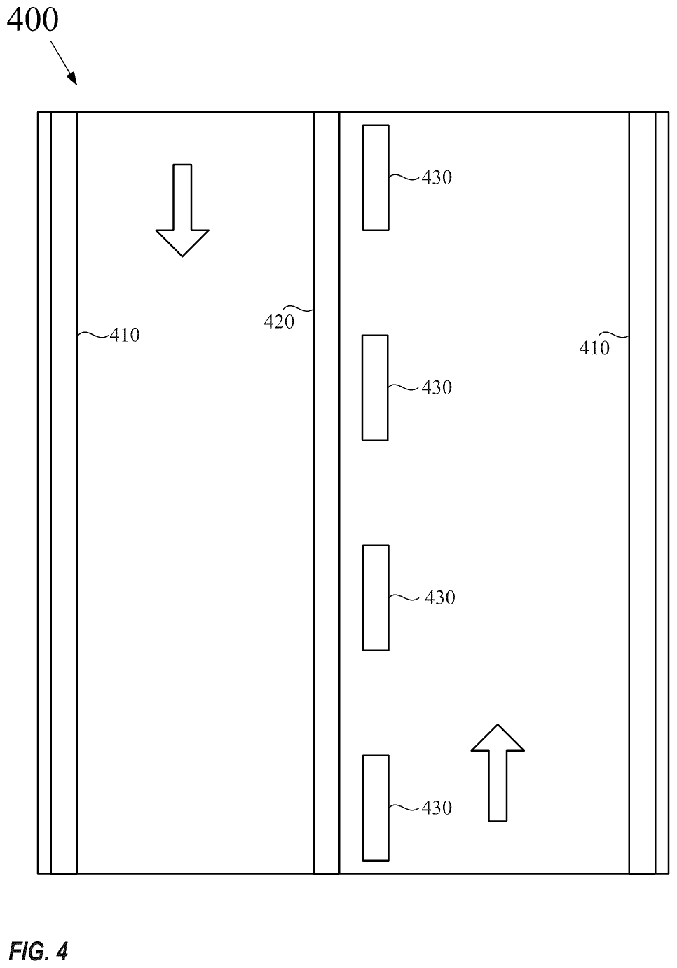

FIG. 2 illustrates an exemplary process flow 200 for applying a polymer modified cement composition to a substrate. The process flow 200 may be focused on markings such as those illustrated in FIG. 4. First, the underlying trafficked pavement substrate may be prepared 210. In some embodiments, the one or more surfaces of the substrate on which the polymer modified cement composition will be applied may be cleaned. For example, loose dust or dirt can be removed with blowers (e.g., industrial blowers). However, if the surface of the substrate is soil contaminated, then the surface may require pressure washing. The one or more surfaces of the substrate on which the polymer modified cement composition will be applied may further be dried-however, it is contemplated that the surface of the substrate may be wet or dry prior to application of the polymer modified cement composition. According to one embodiment, all pavement marking materials may be removed, or masked, using an appropriate technique (e.g., shot blasting, high pressure water blasting, grinding).

The markings required and/or desired for the substrate may then be identified 220. The markings may include, but are not limited to, yellow lines dividing opposite directions on a road, white lines dividing lanes in the same direction, dashed lines indicating passing is allowed, and solid lines indicating no passing. The identification of the lines may include identifying the location (e.g., center of trafficked pavement substrate, edges of trafficked pavement substrate, lane dividers), style (e.g., solid, dashed) and color (e.g., yellow, white). Furthermore, the identification of the lines may also include identifying whether glass beads are to be included in any portions thereof.

The polymer modified cement composition is then prepared 230 as explained above (see also process flow 100 of FIG. 1). The polymer modified cement composition may then be applied to the trafficked pavement substrate at appropriate locations to provide the desired markings 240. The polymer modified cement composition may be applied wet to the trafficked pavement surface so that it ensures an excellent initial and long-term bond. The polymer modified cement composition may be applied as a thin overlay.

According to one embodiment, a vehicle (e.g., striping vehicle) may be utilized to spray the polymer modified cement composition onto the substrate. For example, the vehicle may have one or more nozzles to spray the polymer modified cement composition onto the substrate. In some embodiments, a vehicle (e.g., striping vehicle) may house the first cement mixture and the second mixture in wet forms.

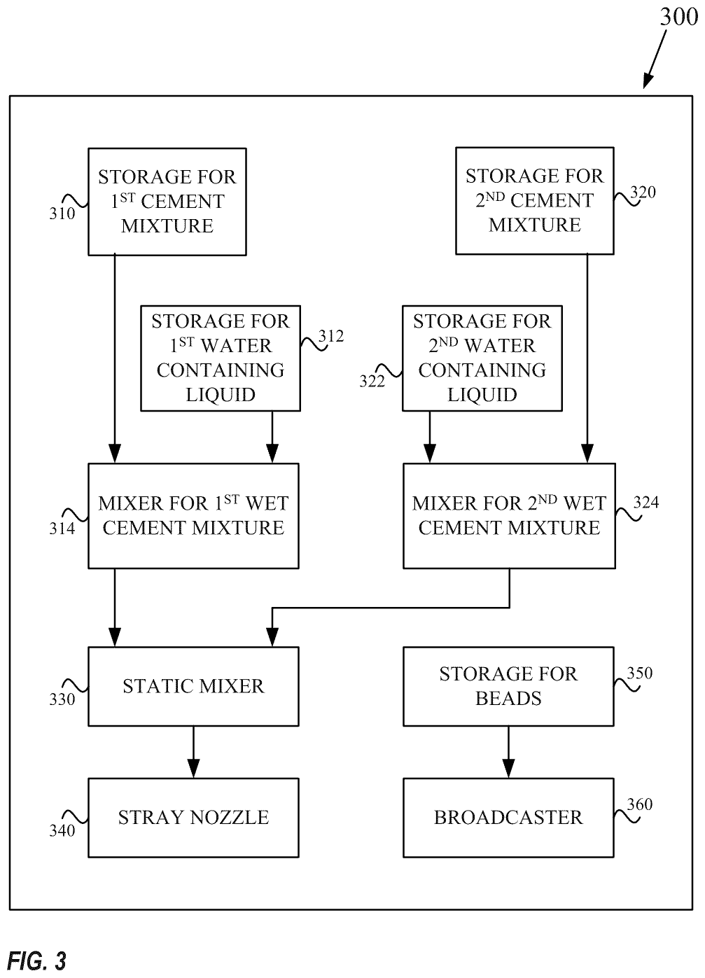

FIG. 3 illustrates block flow diagram of an exemplary striping truck 300 configured to house and apply a polymer modified cement composition to a substrate. The vehicle 300 may include a first storage or housing 310 to house the first cement mixture and a second storage or housing 320 to house the second cement mixture. The vehicle 300 may further include a storage or housing 312 to house the first water containing liquid and a storage or housing 322 to house the second water containing liquid. The vehicle 300 may therefore also include a mixer 314 to combine the first cement mixture with the first water containing liquid to form a wet first cement mixture, and a mixer 324 to combine the second cement mixture with the second water containing liquid to form a second first cement mixture. According to an embodiment where the first water containing liquid and the second water containing liquid are the same, a single storage or housing may be utilized to store the water containing liquid. The single storage or housing may provide an appropriate amount of the water containing liquid to each mixer 314, 324. The vehicle 300 may further include one or more static mixers 330 to mix the first cement mixture (preferably in wet form) and the second cement mixture (preferably in wet form) to create the polymer modified cement composition. For example, the one or more static mixers 330 may include a series of baffles or fins configured to sufficiently mix the cement mixtures and create the polymer modified cement composition. The one or more static mixers 330 may then feed the polymer modified cement composition one or more spray nozzles 340 configured to spray the polymer modified cement composition onto the substrate. The one or more static mixers 330 may be located upstream of the one or more application nozzles 340. In a preferred embodiment, the one or more static mixers 330 may be located immediately upstream the one or more application nozzles 340.

It is contemplated that the overlay formed from the applied polymer modified cement composition may have a thickness of less than or equal to 125 mils, preferably less than or equal to 62.5 mils.

It is contemplated that the overlay may be traffic-ready (or workable) within thirty minutes of application, preferably within fifteen minutes of application, more preferably within 10 minutes of application, most preferably within 5 minutes or within 1 minute of application. These times generally are reproducible even at surface temperatures below 40 degrees F., such as below 35 degrees F. The term “traffic ready” or “workable” means that the overlay is able to withstand vehicular traffic without the overlay tracking/adhering to tires of a vehicle traveling on the overlay.

It is contemplated that time before which the overlay may be traffic-ready or workable is dependent in part on the amount of the second cement mixture, and specifically the amount of cementitious agent, present in the polymer modified cement composition. For example, generally the time before which the overlay may be traffic-ready or workable is directly proportional to amount of cementitious agent present in the composition.

It is contemplated that the overlay may be resistant to traffic-based degradation. It is further contemplated that the overlay may be weather resistant and durable with a long life cycle of a decade or more once applied to the substrate.

In some embodiments, the overlay may include topical aggregate. The topical aggregate may be broadcast on and embedded in the polymer modified composition after application to the substrate. The topical aggregate may be configured to high friction surfacing. The topically applied aggregate is preferably broadcast by mechanical means. Alternatively, the topically applied aggregate is broadcast by hand. Topical aggregates may include, but are not limited to, bauxite, crushed granite, and slag. Topical aggregates and processes for applying topical aggregates are described in for example, U.S. Pat. No. 10,654,751.

In some embodiments, the overlay may include reflective beads 250 as seen in FIG. 2. The reflective beads may be broadcast on and embedded in the polymer modified composition after application to the substrate. The reflective beads may be configured to enhance the visibility of the overlay by retroreflecting automotive headlights to vehicular and/or human traffic. It is contemplated that the overlay may embed up to 60% of the surface area of the reflective beads.

In some embodiments, a single vehicle (e.g., striping vehicle), or a plurality of complimentary vehicles, may be utilized to apply the polymer modified cement composition onto a surface of the substrate and to drop (broadcast) the aggregate and/or reflective beads onto the polymer modified cement composition. As seen in FIG. 3, the vehicle or plurality of vehicles 300 may include one or more storage units 350 for housing the aggregate and/or reflective beads behind the portion of the vehicle where the polymer modified cement composition is sprayed. The storage units may be capable of dropping (broadcasting) the aggregate and/or reflective beads via a broadcaster 360.

FIG. 4 is an exemplary trafficked pavement substrate (e.g., road) 400 with markings. The markings on the road 400 may include lines 410 extending along each edge of the road 100. A line 410 typically identifies in the United States (US) boundaries for a lane in a certain direction. The markings may also include a solid line 420 on the left side of the center of the road 400 and a dashed line 430 on a right side of the center of the road 400. The lines 420, 430 typically indicate in the US that the traffic on the other side of the lines travels in an opposite direction. As illustrated, traffic on left of lines 420, 430 is travelling downward and traffic on right of lines is traveling upward. The various lines 410, 420, 430 could be a thin strip of the polymer modified cement composition applied to the substrate 400. The lines 410 could be provided by continuously applying (e.g., spraying) a polymer modified cement composition to the edges of the substrate 400. Likewise, the line 420 could be provided by continuously applying (e.g., spraying) a polymer modified cement composition to the center of the substrate 400. The line 430 could be provided by intermittently applying (e.g., spraying) according to a desired pattern a polymer modified cement composition to the center of the substrate 400.

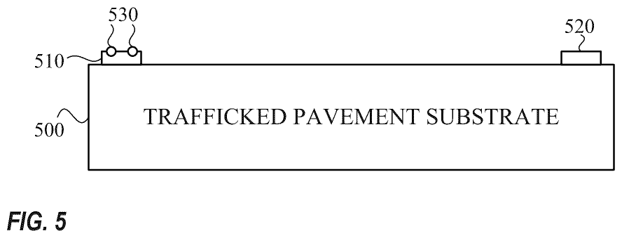

FIG. 5 illustrates an exemplary cross section of a polymer modified cement composition marked substrate. A marked substrate 500 has polymer modified cement composition applied as marking lines 510, 520 on each side thereof. As the polymer modified cement composition is applied as a thin layer (e.g., between 1/75th inch (0.3 mm) to 1/16th inch (1.5 mm)), the marking lines 510, 520 protrude by that amount above the substrate 500. As illustrated, the marking line 510 includes glass beads 530 embedded therein. The glass beads 530 may slightly protrude out of the marking 510.

### Examples

### Example 1—Impact of Amorphous Cementitious Agent Combined with Polymer Concrete Micro Overlay

A comparative composition (e.g., PCMO) was prepared by mixing a dry mix including 45 wt. % of Portland cement, 45 wt. % of an aggregate, 6.5 wt. % of a polymer, and 3.5 wt. % of other components with water (at 16 wt. % of the dry mix) in a mixer capable of mixing a dry mixture with a liquid to form an aqueous composition. An amorphous cementitious agent composition (ACAC) was prepared by mixing dry amorphous cementitious agent mixture with water (at 50 wt. % of the dry mix) in a mixer capable of mixing a dry mixture with a liquid to form an aqueous composition. Inventive compositions (e.g., PCMO and ACAC) were prepared by combining different amounts (e.g., 10 wt. % (First Inventive Example) and 15 wt. % (Second Inventive Example)) of the aqueous ACAC with the aqueous PCMO via a static mixer. The comparative composition and the inventive compositions were applied as an overlay to a concrete substrate at thicknesses between 40-60 mil and at various temperature, weather, and pavement conditions. Thereby the impact of the amorphous cementitious agent on the time before which an overlay is traffic-ready (e.g., cure to traffic) could effectively be measured.

### Results

Cure to Traffic

| | Pavement | Sunny/ | | | | | |
|---|---|---|---|---|---|---|---|
| Temperature | Condition | Overcast/ | Comparative | | First Inventive | Second Inventive | |
| (° F.) | (wet/dry) | Night | Example | | Example | Example | |
| 35 | Dry | Sunny | 4 | hours | — | 15 | minutes |
| 35 | Dry | Night | 6 | hours | — | 20 | minutes |
| 50 | Dry | Overcast | 2 | hours | 10 minutes | 5 | minutes |
| 50 | Wet | Overcast | No | cure | — | 7 | minutes |
| 70 | Dry | Sunny | 30 | minutes | 5 minutes | 2 | minutes |
| 70 | Wet | Overcast | 3 | hours | — | 8 | minutes |

### Discussion

As can be appreciated from the above results, the inventive examples decreased cure to traffic times in all conditions (temperature, weather, and pavement conditions) in comparison to the comparative composition. For example, applying the comparative example overlay to a wet substrate resulted in slow or no cure time. However, the second inventive example provided cure to traffic times of under ten minutes. The inventive examples also provide for quicker cure to traffic times at varying temperatures with a dry substrate and in sunny conditions (e.g., reduced from 4 hours to 15 minutes at 35° F. for second inventive example and from 30 minutes to 5 minutes or 2 minutes at 70° F. for the first and second inventive example respectively). The inventive examples also provide for quicker cure to traffic times at increased amounts of amorphous cementitious agent (e.g., 5 minutes for the first inventive example and 2 minutes for the second inventive example, each applied to a dry substrate in sunny conditions at 70° F.).

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A surface comprising a polymer modified cement composition, wherein the polymer modified cement composition comprises:
a first cement mixture, comprising
a cement,
an aggregate,
a polymer in particulate form, and
a first water-containing liquid; and
a second cement mixture, comprising
a cementitious agent, and
a second water-containing liquid,
wherein the surface is configured for vehicular and/or human transportation.

2. The surface of claim 1, wherein the first water-containing liquid and the second water-containing liquid are the same or different.

3. The surface of claim 1, wherein the polymer in particulate form comprises an acrylate-based compound.

4. The surface of claim 1, wherein the cement comprises partially refined Portland cement.

5. The surface of claim 1, wherein the cementitious agent is an amorphous cementitious agent.

6. The surface of claim 5, wherein the amorphous cementitious agent comprises at least one amorphous compound selected from the group consisting of aluminum oxide, calcium oxide, and silicon dioxide.

7. The surface of claim 5, wherein the amorphous cementitious agent comprises aluminum oxide, calcium oxide, silicon dioxide, and sulfur trioxide.

8. The surface of claim 5, wherein the amorphous cementitious agent comprises a calcium aluminate compound.

9. The surface of claim 1, wherein the cementitious agent is a calcium aluminate compound.

10. The surface of claim 1, wherein the cementitious agent is an amorphous calcium aluminate compound.

11. The surface of claim 1, wherein the first cement mixture further comprises at least one additional component selected from the group consisting of microfibers, plasticizers, fillers, accelerators, and retarders.

12. The surface of claim 1, wherein the second cement mixture further comprises at least one of the aggregate and the polymer in a particulate form.

13. The surface of claim 1, wherein the amorphous cementitious agent is present in an amount of less than 15 wt. % of the total weight of the composition.

14. The surface of claim 1, wherein the cementitious agent is present in an amount of less than 10 wt. % of the total weight of the composition.

15. The surface of claim 1, wherein the aggregate comprises a material selected from the group consisting of marble dust, sand, crushed rocks, and mixtures thereof.

16. A method for providing a polymer modified cement overlay on a surface that is configured for vehicular and/or human transportation, the method comprising:
preparing a wet cement mixture by mixing a dry polymer cement mixture comprising a cement, an aggregate, and a polymer in particulate form with a first water-containing liquid;
preparing a wet calcium aluminate cement mixture by mixing a dry calcium aluminate cement mixture with a second water-containing liquid;
mixing the wet calcium aluminate cement mixture with the wet cement mixture to form a quick setting polymer modified cement composition; and
applying the quick setting polymer modified cement composition to the surface to form the polymer modified cement overlay.

17. The method of claim 16, wherein the dry calcium aluminate cement mixture is amorphous.

18. The method of claim 16, wherein the first water-containing liquid and the second water-containing liquid are the same or different.

19. The method of claim 16, wherein the polymer modified cement overlay is workable within fifteen minutes of application.

20. The method of claim 16, wherein the polymer modified cement overlay is workable within ten minutes of application.

21. The method of claim 16, wherein the polymer modified cement overlay is workable within one minute of application.

22. The method of claim 16, wherein applying the polymer modified cement composition to the substrate comprises spraying the polymer modified cement composition on the one or more surfaces of the substrate.

23. The method of claim 16, wherein applying the polymer modified cement composition to the substrate comprises providing the polymer modified cement composition to a vehicle capable of applying the polymer modified cement composition to the substrate.

24. The method of claim 16, wherein the polymer modified cement overlay has a thickness of less than or equal to 125 mils.

25. The method of claim 16, wherein the polymer modified cement overlay has a thickness of less than or equal to 62.5 mils.

26. The method of claim 16, wherein the surface comprises one or more of asphalt, concrete, and metal.

27. The method of claim 16, wherein the surface is asphalt.

28. The method of claim 16, wherein the surface is concrete.

29. The method of claim 16, further comprising a step of embedding reflective beads into the polymer modified cement overlay.

30. The method of claim 16, wherein the aggregate comprises a material selected from the group consisting of marble dust, sand, crushed rocks, and mixtures thereof.

31. The method of claim 16, wherein applying the polymer modified cement composition includes applying the polymer modified cement composition as markings on the surface.

32. The method of claim 16, wherein the step of mixing the wet calcium aluminate cement mixture with the wet cement mixture includes mixing via a static mixer.

33. The method of claim 16, wherein the step of preparing the wet calcium aluminate cement mixture includes mixing the dry calcium aluminate cement mixture, a portion of the aggregate, and a portion of the polymer with the second water-containing liquid.

34. A method for providing a polymer modified cement overlay on a surface that is configured for vehicular and/or human transportation, the method comprising:
housing a first cement mixture comprising a cement, an aggregate, a polymer in particulate form, and a first water-containing liquid in a striping vehicle;
housing a second cement mixture comprising a cementitious agent and a second water-containing liquid in the striping vehicle, wherein the first water-containing liquid and the second water-containing liquid may be the same or different;
mixing the second cement mixture with the first cement mixture to form a polymer modified cement composition;
applying the polymer modified cement composition from the striping vehicle to the surface to form the polymer modified cement overlay.

35. The method of claim 34, wherein the cementitious agent is an amorphous cementitious agent.

36. The method of claim 34, wherein the polymer modified cement overlay is workable within fifteen minutes of application.

37. The method of claim 34, wherein the polymer modified cement overlay is workable within ten minutes of application.

38. The method of claim 34, wherein the polymer modified cement overlay is workable within one minute of application.

39. The method of claim 34, wherein applying the polymer modified cement composition from the striping vehicle to the substrate comprises spraying the polymer modified cement composition on the surface via one or more nozzles of the striping vehicle.

40. The method of claim 34, wherein the polymer modified cement overlay has a thickness of less than or equal to 125 mils.

41. The method of claim 34, wherein the polymer modified cement overlay has a thickness of less than or equal to 62.5 mils.

42. The method of claim 34, wherein the surface comprises one or more of asphalt, concrete, and metal.

43. The method of claim 34, wherein the surface is asphalt.

44. The method of claim 34, wherein the surface is concrete.

45. The method of claim 34, further comprising a step of embedding reflective beads into the polymer modified cement overlay.

46. The method of claim 34, wherein the aggregate comprises a material selected from the group consisting of marble dust, sand, crushed rocks, and mixtures thereof.

47. The method of claim 34, wherein the step of mixing includes mixing via a static mixer.

48. A method of forming a polymer modified cement composition, comprising:
preparing a first cement mixture comprising a cement, an aggregate, a polymer in particulate form, and a first water-containing liquid;
adding a second cement mixture comprising a cementitious agent and a second water-containing liquid to the cement mixture to form the polymer modified cement composition, wherein the first water-containing liquid and the second water-containing liquid may be the same or different.

49. The method of claim 48, wherein the cementitious agent is an amorphous cementitious agent.

50. The method of claim 49, wherein the amorphous cementitious agent comprises at least one amorphous compound selected from the group consisting of aluminum oxide, calcium oxide, and silicon dioxide.

51. The method of claim 49, wherein the amorphous cementitious agent comprises aluminum oxide, calcium oxide, silicon dioxide, and sulfur trioxide.

52. The method of claim 48, wherein the polymer in particulate form comprises an acrylate-based compound.

53. The method of claim 48, wherein the first cement mixture further comprises at least one additional component selected from the group consisting of microfibers, plasticizers, fillers, accelerators, and retarders.

54. The method of claim 48, wherein the aggregate comprises a material selected from the group consisting of marble dust, sand, crushed rocks, and mixtures thereof.

55. A kit for forming a polymer modified cement composition, the kit comprising:
a cement mixture comprising a cement, an aggregate, and a polymer in particulate form;
a first water-containing liquid;
a cementitious agent; and
a second water-containing liquid, wherein the first water-containing liquid and the second water-containing liquid may be the same or different.

56. The kit of claim 55, wherein the cementitious agent is an amorphous cementitious agent.

57. The kit of claim 55, wherein the amorphous cementitious agent comprises at least one amorphous compound selected from the group consisting of aluminum oxide, calcium oxide, and silicon dioxide.

58. The kit of claim 55, wherein the amorphous cementitious agent comprises aluminum oxide, calcium oxide, silicon dioxide, and sulfur trioxide.

59. The kit of claim 55, wherein the first water-containing liquid is configured to contact the cement mixture to form a liquified cement mixture, and wherein the second water-containing liquid is configured to contact the amorphous cementitious agent to form a liquified amorphous cementitious agent, wherein the liquified amorphous cementitious agent is configured to contact the liquified cement mixture.

60. The kit of claim 55, wherein the polymer in particulate form comprises an acrylate-based compound.

61. The kit of claim 55, wherein the cement mixture further comprises at least one additional component selected from the group consisting of microfibers, plasticizers, fillers, accelerators, and retarders.

62. The kit of claim 55, wherein the aggregate comprises a material selected from the group consisting of marble dust, sand, crushed rocks, and mixtures thereof.

63. A method for preparing a rapidly setting polymer modified cement, the method comprising:
providing a first vessel comprising a cement mixture comprising a cement, an aggregate, a polymer in particulate form, and a first water-containing liquid;
providing a second vessel comprising a cementitious agent slurry comprising a cementitious agent and a second-water containing liquid; and
contacting the cement mixture with the cementitious agent slurry to form a polymer modified cement composition.

64. The method of claim 63, wherein the contacting the cement mixture with the cementitious agent includes providing the cement mixture and the cementitious agent slurry to a static mixer.

65. The method of claim 63, wherein the first water-containing liquid and the second water-containing liquid may be the same or different.

66. The method of claim 63, wherein the polymer in particulate form comprises an acrylate-based compound.

67. The method of claim 63, wherein the cementitious agent is an amorphous cementitious agent.

68. The method of claim 67, wherein the amorphous cementitious agent comprises at least one amorphous compound selected from the group consisting of aluminum oxide, calcium oxide, and silicon dioxide.

69. The method of claim 67, wherein the amorphous cementitious agent comprises aluminum oxide, calcium oxide, silicon dioxide, and sulfur trioxide.

70. The method of claim 63, wherein the cement mixture further comprises at least one additional component selected from the group consisting of microfibers, plasticizers, fillers, accelerators, and retarders.

71. The method of claim 63, wherein the aggregate comprises a material selected from the group consisting of marble dust, sand, crushed rocks, and mixtures thereof.

72. The method of claim 16, wherein the polymer modified cement overlay is workable at surface temperatures below 40 degrees F.

73. The method of claim 34, wherein the polymer modified cement overlay is workable at surface temperatures below 40 degrees F.
